(19) United States
(12) Patent Application Publication
(10) Pub. No.: US 2021/0377804 A1
(43) Pub. Date: Dec. 2, 2021

(54) NETWORK TRAFFIC SPLITTING FOR DUAL CONNECTIVITY USER EQUIPMENT

(71) Applicant: AT&T Intellectual Property I, L.P., Atlanta, GA (US)

(72) Inventors: Rajarajan Sivaraj, Dublin, CA (US); Dhruv Gupta, San Ramon, CA (US); Zhi Cui, Sugar Hill, GA (US); Rittwik Jana, Montville, NJ (US); Nemmara Shankaranarayanan, Bridgewater, NJ (US); Kaustubh Joshi, Short Hills, NJ (US); Sarat Puthenpura, Berkeley Heights, NJ (US)

(21) Appl. No.: 16/890,631

(22) Filed: Jun. 2, 2020

(51) Int. Cl. H04W 28/10; H04W 76/15; H04W 28/02

(52) U.S. Cl. CPC H04W 28/10; H04W 28/0278; H04W 76/15

(57) ABSTRACT

The described technology is generally directed towards network traffic splitting for dual connectivity user equipment. A network controller can monitor communications transmitted between radio access network node devices. The radio access network node devices can be associated with different generation communication protocols. The inter-node communications can be used assess relative performance of the radio access network node devices. For example, buffer growth rates can be estimated for the radio access network node devices, and buffer growth rates can be correlated with network node device performance. The relative performance of the radio access network node devices can then be used to adjust network traffic splits between the radio access network node devices.

### TECHNICAL FIELD

The subject application is related to cellular communication systems, including fifth generation (5G) and other generation cellular communication systems.

### BACKGROUND

A next generation of cellular communication technology is currently being developed and deployed. In the meantime, the previous generation of cellular communication technology remains the predominant technology. At present, the next generation of cellular communication technology is known as fifth generation (5G), and the previous generation of cellular communication technology is known as fourth generation (4G) long term evolution (LTE). Just as 5G is beginning to replace 4G LTE, subsequent generations of cellular communication technology will eventually replace 5G.

As newer generation cellular communication technologies overtake older generation technologies, there is a period of overlap in which user equipment (UE), such as cellular telephones and other mobile devices, can be configured to communicate using either the older generation (4G LTE) or the newer generation (5G) technologies. A UE can communicate via a 5G connection under some circumstances, e.g., when a 5G connection is available and the UE requires high throughput, and the UE can communicate via a 4G LTE connection under other circumstances, for example when the 5G connection is not available. Furthermore, a UE can connect to both 5G and LTE at the same time. The capacity to support two different connection types is known as dual-mode, and UEs that connect to both 5G and LTE links at the same time can be referred to as dual-connectivity UEs.

Among the many advances included in 5G are features which generally provide better understanding and control over radio access network (RAN) equipment. Such features can be leveraged for more intelligent network traffic control within 5G networks. However, in order to optimize performance of cellular communications as a whole, there is a need for greater cooperation between network equipment of different generations. There is a need to intelligently direct traffic from dual-mode or dual connectivity UEs to a most appropriate network connection type, or to split traffic properly between the two technologies based on current network conditions.

The above-described background relating to digital navigational mapping technology is merely intended to provide a contextual overview of some current issues, and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless communication system, in accordance with various aspects and embodiments of the subject disclosure.

FIG. 2 illustrates example dual connectivity with a 4G/5G protocol stack in non-stand-alone mode, in accordance with various aspects and embodiments of the subject disclosure.

FIG. 3 illustrates an example near-real-time RAN intelligent controller (near-RT RIC) coupled with network nodes that implement different network communication protocols, in accordance with various aspects and embodiments of the subject disclosure.

FIG. 4 illustrates an example user equipment (UE), in accordance with various aspects and embodiments of the subject disclosure.

FIG. 5 illustrates an example RAN device, in accordance with various aspects and embodiments of the subject disclosure.

FIG. 6 illustrates an example network controller device, in accordance with various aspects and embodiments of the subject disclosure.

FIG. 7 is a flow diagram representing example operations of a network controller device, in accordance with various aspects and embodiments of the subject disclosure.

FIG. 8 is a flow diagram representing another example set of operations of a network controller device, in accordance with various aspects and embodiments of the subject disclosure.

FIG. 9 is a flow diagram representing example operations of a network node device, in accordance with various aspects and embodiments of the subject disclosure.

FIG. 10 is a block diagram of an example computer that can be operable to execute processes and methods in accordance with various aspects and embodiments of the subject disclosure.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details, and without applying to any particular networked environment or standard.

One or more aspects of the technology described herein are generally directed towards network traffic splitting for dual connectivity user equipment. A network controller can monitor communications transmitted between radio access network node devices. The radio access network node devices can be associated with different generation communication protocols. The inter-node communications can be used assess relative performance of the radio access network node devices. For example, buffer growth rates can be estimated for the radio access network node devices, and buffer growth rates can be correlated with network node device performance. The relative performance of the radio access network node devices can then be used to adjust network traffic splits between the radio access network node devices.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

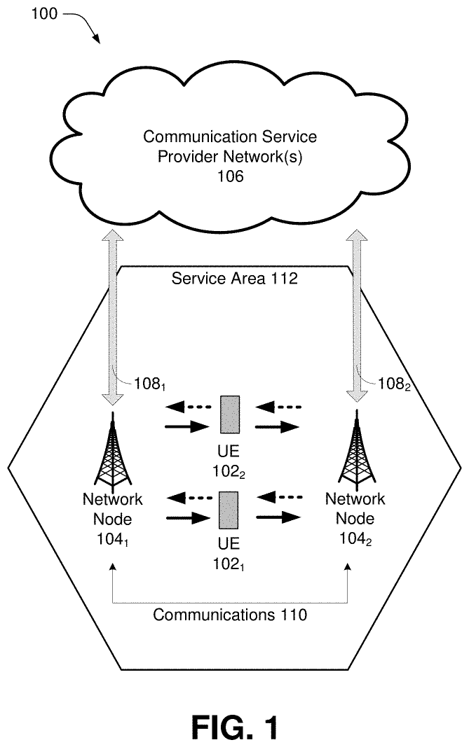

FIG. 1 illustrates a non-limiting example of a wireless communication system 100 which can be used in connection with at least some embodiments of the subject disclosure. In one or more embodiments, system 100 can comprise one or more user equipment UEs 1021, 1022, referred to collectively as UEs 102, network nodes 1041, 1042, referred to collectively as network nodes 104, and communication service provider network(s) 106. The network nodes 104 can provide cellular service in a service area 112. The network nodes 104 can communicate directly with each other via communications 110, as well as with the communication service provider network(s) 106 via backhaul links 1081 and 1082.

The non-limiting term “user equipment” can refer to any type of device that can communicate with network nodes 104 in a cellular or mobile communication system 100. UEs 102 can have one or more antenna panels having vertical and horizontal elements. Examples of UEs 102 comprise target devices, device to device (D2D) UEs, machine type UEs or UEs capable of machine to machine (M2M) communications, personal digital assistants (PDAs), tablets, mobile terminals, smart phones, laptop mounted equipment (LME), universal serial bus (USB) dongles enabled for mobile communications, computers having mobile capabilities, mobile devices such as cellular phones, laptops having laptop embedded equipment (LEE, such as a mobile broadband adapter), tablet computers having mobile broadband adapters, wearable devices, virtual reality (VR) devices, heads-up display (HUD) devices, smart cars, machine-type communication (MTC) devices, augmented reality head mounted displays, and the like. UEs 102 can also comprise IOT devices that communicate wirelessly.

In various embodiments, system 100 comprises communication service provider network(s) 106 serviced by one or more wireless communication network providers. Communication service provider network(s) 106 can comprise a “core network”. In example embodiments, UEs 102 can be communicatively coupled to the communication service provider network(s) 106 via network nodes 104. The network nodes 104 (e.g., network node devices) can communicate with UEs 102, thus providing connectivity between the UEs 102 and the wider cellular network. The UEs 102 can send transmission type recommendation data to the network nodes 104. The transmission type recommendation data can comprise a recommendation to transmit data via a closed loop MIMO mode and/or a rank-1 precoder mode.

Network nodes 104 can have cabinets and other protected enclosures, computing devices, an antenna mast, and multiple antennas for performing various transmission operations (e.g., MIMO operations) and for directing/steering signal beams. Network nodes 104 can comprise one or more base station devices which implement features of the network nodes 104. Network nodes can serve several cells, also called sectors, depending on the configuration and type of antenna. In example embodiments, UEs 102 can send and/or receive communication data via wireless links to the network nodes 104. The dashed arrow lines from the network nodes 104 to the UEs 102 represent downlink (DL) communications and the solid arrow lines from the UEs 102 to the network nodes 104 represents uplink (UL) communications.

Communication service provider networks 106 can facilitate providing wireless communication services to UEs 102 via the network nodes 104 and/or various additional network devices (not shown) included in the one or more communication service provider networks 106. The one or more communication service provider networks 106 can comprise various types of disparate networks, including but not limited to: cellular networks, femto networks, picocell networks, microcell networks, internet protocol (IP) networks Wi-Fi service networks, broadband service network, enterprise networks, cloud based networks, millimeter wave networks and the like. For example, in at least one implementation, system 100 can be or comprise a large scale wireless communication network that spans various geographic areas. According to this implementation, the one or more communication service provider networks 106 can be or comprise the wireless communication network and/or various additional devices and components of the wireless communication network (e.g., additional network devices and cell, additional UEs, network server devices, etc.).

The network nodes 104 can be connected to the one or more communication service provider networks 106 via one or more backhaul links 1081 and 1082, referred to collectively herein as backhaul links 108. For example, the one or more backhaul links 108 can comprise wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 108 can also comprise wireless link components, such as but not limited to, line-of-sight (LOS) or non-LOS links which can comprise terrestrial air-interfaces or deep space links (e.g., satellite communication links for navigation). In an embodiment, network nodes 104 can be part of an integrated access and backhaul network. This may allow easier deployment of a dense network of self-backhauled 5G cells in a more integrated manner by building upon many of the control and data channels/procedures defined for providing access to UEs.

Wireless communication system 100 can employ various cellular systems, technologies, and modulation modes to facilitate wireless radio communications between devices (e.g., the UEs 102 and the network nodes 104). In particular, the network node 1041 can employ a previous generation cellular technology, such as 4G LTE, while the network node 1042 can employ a subsequent generation cellular technology, such as 5G. The UEs 102 can be capable of operating in dual mode, that is, UEs 102 can communicate with either or both of the network nodes 104. While example embodiments might be described for 4G LTE and 5G new radio (NR) systems, the embodiments can be applicable to any two generations of cellular communications technology, e.g. 5G and 6G, or different versions of these.

For example, system 100 can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-FDMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system 100 are particularly described wherein the devices (e.g., the UEs 102 and the network nodes 104) of system 100 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, system 100 can be configured to provide and employ 4G LTE, 5G, or subsequent generation wireless networking features and functionalities. 5G wireless communication networks are expected to fulfill the demand of exponentially increasing data traffic and to allow people and machines to enjoy gigabit data rates with virtually zero (e.g., single digit millisecond) latency. Compared to 4G, 5G supports more diverse traffic scenarios. For example, in addition to the various types of data communication between conventional UEs (e.g., phones, smartphones, tablets, PCs, televisions, internet enabled televisions, etc.) supported by 4G networks, 5G networks can be employed to support data communication between smart cars in association with driverless car environments, as well as machine type communications (MTCs). Considering the drastic different communication needs of these different traffic scenarios, the ability to dynamically configure waveform parameters based on traffic scenarios while retaining the benefits of multi carrier modulation schemes (e.g., OFDM and related schemes) can provide a significant contribution to the high speed/capacity and low latency demands of 5G networks. With waveforms that split the bandwidth into several sub-bands, different types of services can be accommodated in different sub-bands with the most suitable waveform and numerology, leading to an improved spectrum utilization for 5G networks.

To meet the demand for data centric applications, features of proposed 5G networks can comprise: increased peak bit rate (e.g., 20 Gbps), larger data volume per unit area (e.g., high system spectral efficiency—for example about 3.5 times that of spectral efficiency of long term evolution (LTE) systems), high capacity that allows more device connectivity both concurrently and instantaneously, lower battery/power consumption (which reduces energy and consumption costs), better connectivity regardless of the geographic region in which a user is located, a larger numbers of devices, lower infrastructural development costs, and higher reliability of the communications. Thus, 5G networks can allow for: data rates of several tens of megabits per second should be supported for tens of thousands of users, 1 gigabit per second to be offered simultaneously to tens of workers on the same office floor, for example; several hundreds of thousands of simultaneous connections to be supported for massive sensor deployments; improved coverage, enhanced signaling efficiency; reduced latency compared to LTE.

The upcoming 5G access network can utilize higher frequencies (e.g., >6 GHz) to aid in increasing capacity. Currently, much of the millimeter wave (mmWave) spectrum, the band of spectrum between 30 GHz and 300 GHz is underutilized. The millimeter waves have shorter wavelengths that range from 10 millimeters to 1 millimeter, and these mmWave signals experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the 3GPP and has been in use (including with LTE), is a multi-antenna technique that can improve the spectral efficiency of transmissions, thereby significantly boosting the overall data carrying capacity of wireless systems. The use of MIMO techniques can improve mmWave communications and has been widely recognized a potentially important component for access networks operating in higher frequencies. MIMO can be used for achieving diversity gain, spatial multiplexing gain and beamforming gain. For these reasons, MIMO systems are an important part of the 3rd and 4th generation wireless systems and are planned for use in 5G systems.

In an example embodiment according to FIG. 1, the UEs 102 can comprise dual mode UEs, e.g., the UEs 102 can be enabled to communicate with both a 4G LTE network node 1041 and a 5G network node 1042. For example, in an embodiment, UE 1021 can simultaneously direct a portion of its communications to the 4G LTE network node 1041 and a different portion of its communications to the 5G network node 1042. An instruction to a UE 1021 from communication service provider networks 106 can adjust a balance of UE 1021 communications transmitted via network node 1041 versus UE 1021 communications transmitted via network node 1042.

By directing more of the communications of UEs 102 to network node 1042, an additional network traffic burden is placed on network node 1042. Conversely, by directing more of the communications of UEs 102 via network node 1041, the network traffic on network node 1042 is decreased while the network traffic on network node 1041 is increased. Under sufficient network traffic burden, either of the network nodes 104 can begin to slow down. Embodiments of this disclosure can be directed to ascertaining performance of the network nodes 104, and balancing network traffic between the network nodes 104 in order to benefit overall performance of the network nodes 104.

In general, embodiments of this disclosure can configure the communication service provider network(s) 106 to monitor communications 110 between network nodes 104. The backhaul links 108 may be referred to as comprising “E2” interfaces which connect the communication service provider network(s) 106 with radio access network nodes 104. The link between network nodes 104, for communications 110, may be referred to as comprising an “X2” interface. X2 interfaces are typically used, inter alia, to coordinate wireless transmissions of network nodes 104 in order to avoid radio interference.

Embodiments of this disclosure can monitor X2 interface communications 110 via E2 interface communications over backhaul links 108. Various techniques described herein can be used to process communications 110 in order to determine or predict relative network traffic burdens on network nodes 104. The communication service provider network(s) 106 can then adjust network traffic to appropriately balance the burden, e.g., by directing UEs 102 to operate in a desired communication mode.

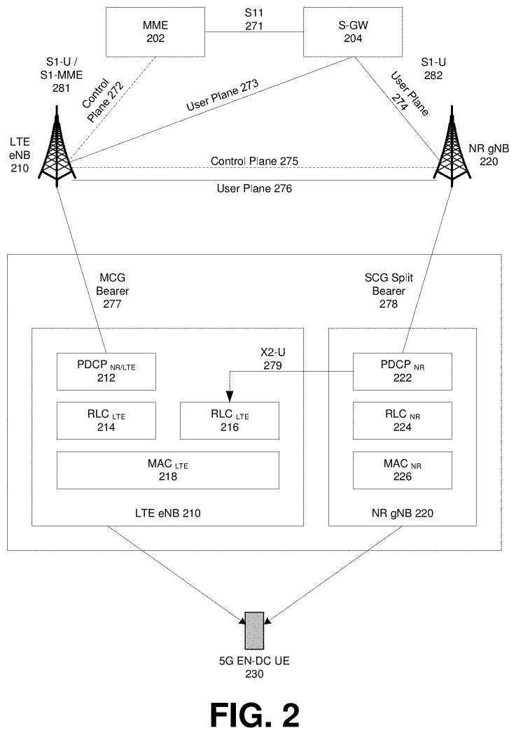

FIG. 2 illustrates example dual connectivity with a 4G/5G protocol stack in non-stand-alone mode. FIG. 2 illustrates a mobility management entity (MME) 202, a serving gateway (S-GW) 204, an LTE evolved-Node B (eNB) base station 210, a new radio (NR) next generation Node B (gNB) base station 220, and a 5G EUTRA-NR Dual Connectivity (EN-DC) UE 230. EUTRA refers to evolved universal mobile telecommunications system terrestrial radio access.

The LTE eNB 210 protocol stack includes a packet data convergence protocol (PDCP_{NR/LTE}) unit 212, two radio link control (RLC_{LTE}) units 214 and 216, and a medium access control (MAC_{LTE}) unit 218. The NR gNB 220 protocol stack includes a PDCP_{NR} unit 222, an RLC_{NR} unit 224, and a MAC_{NR} unit 226.

The MME 202 is connected to the S-GW 204 by an S11 interface 271. There is an S1-U/S1-MME interface 281 and a control plane 272 between the LTE eNB 210 and the MME 202. There is an S1-U interface 282 and a user plane 274 between the NR gNB 220 and the S-GW 204. There is also a user plane 273 between the LTE eNB 210 and the S-GW 204. Furthermore, there is a control plane 275 and a user plane 276 between the LTE eNB 210 and the NR gNB 220. A master cell group (MCG) bearer 277 connects the LTE eNB 210 and the PDCP_{NR/LTE} unit 212. A secondary cell group (SCG) split bearer 278 connects the NR gNB 220 and the PDCP_{NR} unit 222. An X2-U interface 279 connects the PDCP_{NR} unit 222 and the RLC_{LTE} unit 216.

The initial nation-wide 5G NR operations are in millimeter wave (mmwave) frequencies. Mobile network operators are deploying their 5G carriers in non-stand-alone (NSA) mode, meaning that 5G NR would not be served to the users as a stand-alone connection, but would co-exist with 4G LTE. In NSA mode, a UE 530 can access a 5G NR connection from a mmwave cellular base station (called next generation-Node B or alternatively, gNB), if and only if it is also simultaneously connected to an LTE base station (called evolved-Node B or alternatively, eNB). This connection mode of the UE 230 is called EUTRA-NR Dual Connectivity, or EN-DC. This requires a UE 230 to have a multi-radio access technique (multi-RAT) chipset. While the RAN control plane functions (such as radio resource connection or RRC, mobility management, etc.) can be exclusively handled by the LTE eNB 210, the user-plane RAN functions dealing with data transfer to the UEs can be jointly handled by both the NR gNB 220 as well as the LTE eNB 210.

In EN-DC NSA 3X, which is a widely-used option of NSA mode, the eNB 210 solely interfaces with the MME 202 of the core network over the S1AP interface for managing control plane functions of the UE, while the gNB 220 anchors the UE-subscribed data from the core network (i.e. from the serving gateway or S-GW 204 via the S1-U interface 282. The gNB 220 further decides how large a fraction of the UE 230 subscribed traffic can be sent to the UE 230 over the NR interface across time. Accordingly, it forwards the remaining portion of the traffic to the eNB 210 over the X2 interface 279, which can further be sent to the UE 230 over LTE.

A near-real-time RAN intelligent controller (near-RT RIC) is a centralized programmable component, architected based on open RAN (O-RAN) alliance standards, that performs selected Radio Resource Management (RRM) functions, which were traditionally performed in the RAN baseband units (BBUs), by leveraging software defined networking (SDN) principles, which decouple the control plane network functions of the RAN from the user plane. The control plane Network Functions (NFs) from across the RAN BBUs are migrated to the near-RT RIC via standardized interfaces, which are also used to update the near-RT RIC with fine-grained RAN state information about the BBUs. Near-RT RIC then sends closed-loop control actions back to the RAN to execute these network functions. The advantage in migrating network functions to the near-RT RIC lies in availing (i) global RAN state intelligence from across multiple RAN BBUs controlled by the near-RT RIC and the inter-dependencies among the NFs of the BBUs, (ii) programmability and enhanced intelligence to come up with adaptive, customized and optimized solutions for fine-grained radio resource management of RAN NFs on a per-UE per-bearer per-flow basis, by making use of granular global RAN data and leveraging RAN state persistence, (iii) opening up the RAN to 3rd party intelligent micro-services, called external apps (or xApps) that would foster an open, innovative and competitive ecosystem with support for multi-vendor inter-operability. The near-RT RIC communicates with the RAN using an E2 interface.

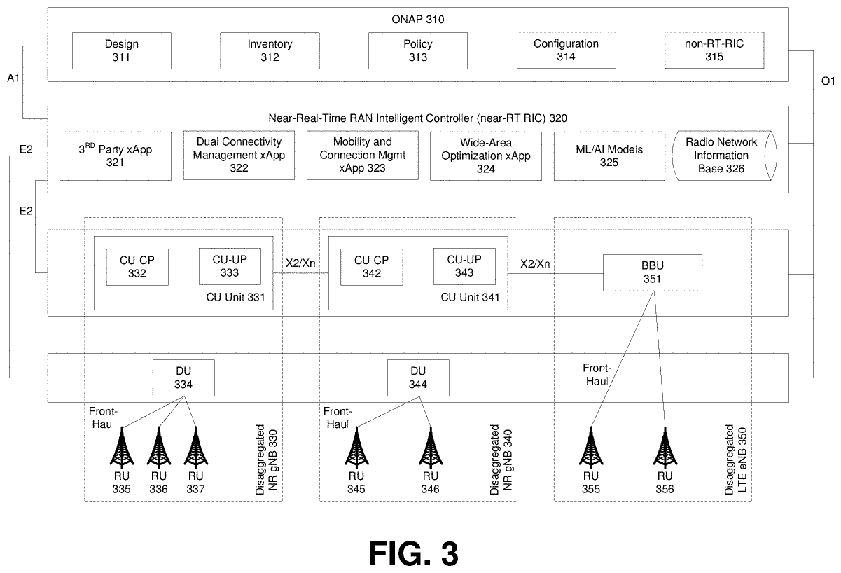

Aspects of this disclosure include methods to intelligently split the user-subscribed data traffic of 5G EN-DC UEs 230 across LTE and NR radio interfaces so as to minimize the downlink RAN user-plane latency. As will be described in connection with FIG. 3, embodiments can use a near-RT RIC and an E2 interface making use of the E2AP protocol, where E2AP can comprise an extension of X2AP. In a further aspect, a micro-service xApp at the near-RT RIC can intelligently estimate the instantaneous buffer state and predict the rate of growth in the buffer size at the eNB and gNB to intelligently split traffic across the two interfaces for a 5G EN-DC UE 230, so as to minimize the RAN latency in transmitting IP packets of the UE-subscribed traffic flow. Embodiments can make use of 3GPP X2AP messages sent between the eNB and gNB that are exposed to the near-RT RIC over E2 (as part of E2AP) to facilitate the near-RT RIC micro-services xApp to do intelligent traffic-split for the 5G EN-DC UE 230 based on predicted buffer state information at the eNB and gNB. Towards this end, the near-RT RIC can make use of the following example X2AP messages: secondary RAT data usage report; SN status transfer; SgNB addition request; resource status update; and RRC transfer.

Intelligent traffic splitting is useful in view of the fact that LTE and NR RATs have different channel characteristics resulting in varying degrees of attenuations for the UE. For example, LTE operates at 700 MHz or 2 GHz or sub-6 GHz, while mmwave operates at 39 GHz). LTE and NR RATs also have different operating channel bandwidths (such as 10 MHz in single cell LTE, versus 100 MHz in single-cell mmwave) and could have varying cell load and traffic conditions, resulting in varied bandwidth allocation from their respective sub-bands to the UE. There are also differences in RAN protocol stack functions between LTE and NR. Different 5G mobile applications have different service requirements and varying traffic profiles, e.g., low-latency requirements for ultra-reliable low-latency communication (uRLLC) traffic such as mission critical communication, remote surgery, factory automation, and intelligent transportation, and high bandwidth low-latency requirements for enhanced mobile broadband (eMBB) traffic such as AR/VR, 360 live 4K/8K video streaming, etc.

EN-DC is expected to improve throughput and is also expected to yield improvements in RAN latency. An optimal traffic split in EN-DC using near-RT RIC, which is equipped with global state information containing data about the RAN (eNBs/gNBs), cells (LTE and NR), UEs and their subscribed traffic profiles, etc., can yield further improvements in crucial network Key Performance Indicators (KPIs), service guarantees and Quality-of-Experience (QoE) for cellular service customers, especially in provisioning 5G applications such as uRLLC (e.g., communications with a minimum of 1 ms data plane and 10 ms control-plane latency), eMBB (e.g., communications with a minimum of 4 ms data plane latency and 10 s of Mbps of bit-rates), etc. In addition to improvements in EN-DC performance by optimized traffic split, near-RT RIC can also enable us to predicting other relevant metrics, such as buffer state of the eNB and gNB, throughput, etc., from data exposed by the RAN over the E2 interface.

### Overview of a Disaggregated RAN Architecture

A RAN can comprise 4G LTE eNBs and disaggregated 5G NR gNBs. Generally, RAN base station can be composed of a Base-Band Unit (BBU) and many Radio Units (RUs). The BBUs process the network functions across the RAN protocol stack, while the RUs manage the forwarding of radio transmissions to the UE. Traditionally, the BBU and RUs are co-located in the same cell sites. With disaggregated RAN, the BBU is moved to a BBU pool located at a centralized cloud or data center, closer to the mobile edge. Leveraging cloud-scale economics, moving the BBUs to a BBU pool enables efficient sharing of computational and storage resources across BBUs.

Based on SDN principles, the BBU can be functionally disaggregated into a logical Centralized Unit (CU) that manages higher RAN layer control and user plane network functions (such as user connection, traffic flow management, call admission, etc.) and one or more logical Distributed Units (DU) managing lower RAN layer data plane network functions (such as rate/resource allocation, handling retransmissions, user buffers, etc.) and forwarding components. The CU connects the gNB to the core network via standardized 3GPP interfaces that perform both user-plane and control-plane core network functions. The former takes care of delivering IP packets for user subscribed traffic flows to the RAN and the latter manages state information of user mobility and connection to the core network via the RAN for call/session processing.

The CU can be further decomposed into a logical Control Plane (CP) unit called CU-CP, and one or more logical User Plane (UP) units, called CU-UPs. In terms of the RAN protocol stack, the SDAP and PDCP layers are managed in the CU-UP(s), while the RRC layer is managed in the CU-CP and the RLC/MAC/PHY-U are managed in the DUs, and the RF transmission (lower PHY) is managed in the RUs. The network functions of the CU-CP are functionally split with the near-RT RIC that performs selected Radio Resource Management (RRM) functions, which were traditionally managed in the CU-CP, and executes them via closed-loop control actions back to the RAN. A further component can be used for SDN/NFV resource orchestration, like the Open Network Automation Platform (ONAP), to provide policies and objectives concerning RRM to the near-RT RIC.

We collectively call CU-CPs, CU-UPs, DUs and BBUs as RAN nodes. Using network function virtualization (NVF), the split network functions from the RAN nodes across eNBs and gNBs can be moved to different virtual machines (VMs) as software implementations deployed across cell sites, baseband pools and clusters, mobile edge cloud and central cloud.

Note that an LTE eNB communicates with the NR gNB over the standard 3GPP (3^{rd} Generation Partnership Project) X2 interface. X2 is also used by eNBs to communicate with each other. gNBs interface with each other using Xn. F1 is used to interface the CU with the DU, while E1 is used to interface the CU-CP with the CU-UP. The O-RAN standardized E2 is the interface between the near-RT RIC with the CU-CP. Furthermore, real-time control loops called Loop 1, carried out by DUs and RUs, operate in timescales in the order of 1 ms; while near-real-time loops, typically done in CUs and near-RT RIC, range from 5 to 500 ms and non-real-time loops, enforcing RAN management policies from the non-RT-RIC (deployed in ONAP), are in timescales greater than 500 ms.

### Overview of the Near-RT RIC Functional Architecture

The near-RT RIC makes intelligent RRM decisions for wide-area optimization of Loop 2 CU-CP network functions across gNBs and eNBs within a given regional geography. The near-RT RIC component is typically deployed in an edge cloud that covers a large metropolitan area of gNBs and eNBs. The reason for the near-RT RIC to be considered as a functional split of the CU-CP is because the near-RT RIC, like the CU-CP, controls the operations of the underlying CU-UP(s) and DU(s) on a per-UE basis. While the DUs have their own localized RRM decisions for Loop 1, network functions for Loop 2 like those on CU-UP are mostly data forwarding functions based on RRM decisions at CU-CP. The near-RT RIC performs these RRM functions in an intelligent manner, subject to optimization objectives, by leveraging real-time RAN data and policy guidance for RAN management. Towards this end, the near-RT RIC has primarily two control interfaces: E2 and A1. The E2 interface is used by the RAN to feed fine-grained per-UE data to the near-RT RIC to facilitate enhanced RRM, and by the near-RT RIC to convey control actions and policies directly to the CU/DU. The northbound A1 interface provides policy orchestration and management functions, provided by ONAP. Intelligent models can generate enhanced policy guidance to the near-RT RIC via A1.

By exposing fine-grained RAN data, the near-RT RIC aims to promote an intelligent, agile and continuously evolving RAN by fostering the creation of a multi-vendor open ecosystem of inter-operable components for a disaggregated RAN. This can further be imbued with network-AI from a variety of sources. To this end, the near-RT RIC is designed as an extensible real-time micro-services framework (as explained below) with embedded ML intelligence and key SDN control interfaces. These enable fine-grained and enhanced UE specific RRM operations at the RAN by the near-RT RIC, concerning mobility management, spectrum resource and QoS management, load balancing, interference coordination, RAN slicing, etc. Further, the near-RT RIC is designed to be compatible with legacy RAN functionalities which would still be able to operate normally (albeit in non-enhanced mode) in the event of near-RT RIC failure.

FIG. 3 illustrates an example near-real-time RAN intelligent controller (near-RT RIC) coupled with network nodes that implement different network communication protocols, in accordance with various aspects and embodiments of the subject disclosure. FIG. 3 includes an ONAP layer 310, a near real-time RAN intelligent controller (near-RT RIC) 320, and three example network nodes, including a disaggregated NR gNB 330, a disaggregated NR gNB 340, and a disaggregated LTE eNB 350. The ONAP 310 includes various example components such as design 311, inventory 312, policy 313, configuration 314, and non-real-time RAN Intelligent Controller (non-RT-RIC) 315. The near-RT RIC 320 includes various example components such as 3^{rd} party xApp 321, dual connectivity management xApp 322, mobility and connection management xApp 323, wide-area optimization xApp 324, ML/AI models 325 and radio network information base 326. The dual connectivity management xApp 322 can be configured to handle measurement and balancing of network traffic according to some embodiments of this disclosure.

The disaggregated NR gNB 330 includes CU unit 331, comprising CU-CP 332 and CU-UP 333. The disaggregated NR gNB 330 further includes DU 334 and RUs 335, 336, and 337. The disaggregated NR gNB 340 includes CU unit 341, comprising CU-CP 342 and CU-UP 343. The disaggregated NR gNB 340 further includes DU 344 and RUs 345 and 346. The disaggregated NR gNB 350 includes BBC 351 and RUs 355 and 356.

Near-RT RIC 320 can be a regionalized, programmable component, controlling the RAN nodes, i.e., the CU-CP, CU-UP and DU units across 5G gNBs and BBUs across 4G eNBs, covering a large geographical area. The gNBs and eNBs can be connected to each other via 3GPP-standard X2/Xn interfaces as shown in FIG. 3. Using the E2 interface, the near-RT RIC 320 can obtain fine-grained RAN state information and compute performance indicators (KPIs) in near real-time. Intelligent micro-services in the near-RT RIC (called xApps) can use these KPIs and implement RRM algorithms for wide-area RAN optimization. On the other hand, ONAP 310 receives KPIs from the CU-CP, CU-UP and DU units across 5G gNBs and the BBUs across 4G eNBs over the Operations, Administration and Management (OA&M) interface O1 at relatively coarser granularity and uses this dataset to build intelligence guidance models. These are further used for setting policies and service objectives to the near-RT RIC 320 over the A1 interface.

Functional design principles of the near-RT RIC 320 can include, inter alia, CU-CP functional split and near-RT RIC processing over E2. In the traditional non-disaggregated RAN, all control plane processing occurs inside the CU-CP. In a disaggregated design, control plane processing with the near-RT RIC follows a synchronous request-response approach, i.e., when an event happens, the relevant control plane processing is suspended in the CU-CP, which then signals and delegates up to the near-RT RIC to perform the appropriate call processing through one of its xApps. The output from the near-RT RIC xApp algorithm is subsequently delivered in the form of a closed-loop control action (e.g., handoff, admission control, bearer reconfiguration, etc.) back to the CU-CP for completion of the control plane processing. To migrate network functions with lower latency demands, the near-RT RIC xApps can have predictive intelligence to proactively and accurately foresee changes in the RAN state and make optimized RRM decisions. Accordingly, the near-RT RIC xApps can also asynchronously initiate (i) a closed-loop control action for individual calls asynchronously to the CU-CP to intelligently process relevant NFs in a fine-grained manner, or (ii) a generic policy directive to the CU-CP, applicable across all calls and which may adapt over coarser time-scales. Network functions for traditional control plane processing between the CU-CP and CU-UPs (over E1), and between CU-CP and DUs (over F1) can be migrated to the near-RT RIC xApps. Enhanced RRM decisions from the xApps can control those network functions with CU-UPs and DUs.

Functional design principles of the near-RT RIC 320 can furthermore include network function virtualization and RAN state information persistence. The near-RT RIC 320 can make use of fine-grained RAN state information over E2 from the RAN nodes for intelligent RRM decisions. This can include storing RAN state information from these RAN components with some degree of finite persistence (in terms of the historical length of time for storing the information). Radio-Network Information Base (R-NIB) 326 is an in-memory database inside the near-RT RIC 320, meant to store such RAN state information, exploring functional interdependencies between the RAN nodes 330, 340, 350. The RAN nodes 330, 340, 350 can send their state information over E2 either following a triggered event or at regular periodic intervals. Predictive intelligence techniques used in xApps may count on historical RAN state information from the nodes 330, 340, 350 and hence, the R-NIB 326 can maintain finite persistence. The near-RT RIC xApps and the R-NIB 326 can be deployed as micro-services in VM clusters on Commercial Off-the-shelf (COTS) platforms with sufficient compute, network and storage capabilities. Hence, xApps can perform control plane processing using virtualized network functions (VNF) over E2 and can thus be implemented as VNF instances in the near-RT RIC 320, leveraging shared resources for cloud scale economics.

Functional design principles of the near-RT RIC 320 can furthermore include xApp management via the O1 interface. The O-RAN alliance defines the O1 interface, also referred to as the OA&M interface, to enable the ONAP 310 to ensure proper functioning of the near-RT RIC elements (xApps, R-NIB, etc.) and RAN nodes 330, 340, 350. An O1 interface, as shown in FIG. 3, is present across the RAN nodes 330, 340, 350 and the near-RT RIC 320 to connect with the ONAP 310. The O1 interface's responsibility includes (i) onboarding, deployment, activation, life cycle and computational resource management of xApps for performance guarantees, (ii) managing subscriptions to RAN data and KPIs from RAN nodes at the ONAP, (iii) controlling the access of xApps to the R-NIB 326 for read, write and update operations, (iv) controlling how multiple xApps can be service chained to perform complex RRM decisions.

Functional design principles of the near-RT RIC 320 can furthermore include policy guidance via the A1 interface. The near-RT RIC xApps make optimized RRM decisions, subject to policy guidance, from the non-RT-RIC 315 to the near-RT RIC 320 over the A1 interface. Some examples of RAN policy guidance include (i) assignment of KPI optimization and service objectives (e.g., cell-specific throughput, spectrum utilization, UE-specific guaranteed bit rate, etc.) for RAN and UEs, (ii) setting RAN parameter threshold configurations (e.g., signal strength thresholds for handover), (iii) prioritizing or blacklisting of cells and bands for carrier aggregation, traffic offload, load balancing, etc., (iv) Support for policy-based guidance of near-RT RIC functions, deploying/updating AI/ML models into near-RT RIC, and feedback mechanisms from near-RT RIC to ensure service objectives.

Some of the means of getting fine-grained RAN state information over the E2 interface from the gNB/eNB include: 1. Exposing functions pertaining to 3GPP standard X2 (X2AP, X2U), F1 (F1AP, F1U), E1 (E1AP), S1 (S1AP, S1U), NGAP (N2, N3) etc. interfaces of the RAN nodes 330, 340, 350 over the E2; 2. Exposing RAN internal functions at the RAN nodes 330, 340, 350 pertaining to UE, Cell, Bearer, flows, etc. over E2; and 3. Exposing computed RAN KPIs at finer granularities (tens to hundreds of milliseconds) over E2, etc.

In a version of the near-RT RIC platform, the E2 Application Protocol (or E2AP) is defined as an extension of X2AP. In particular, the near-RT RIC 320 can be configured as a “pseudo eNB” to satisfy backward compatibility with the X2AP specification. The near-RT RIC 320 interfaces with the gNB CU-CP using E2. This enables the E2AP to serve as an extension of a subset of X2AP messages (3GPP TS 36.423 Rel 15), exchanged between LTE eNB and NR gNB CU-CP. As far as the 4G eNBs are concerned, the near-RT RIC 320 uses an X2 interface with them, since the near-RT RIC 320 is configured as a “pseudo eNB”. This means any UE-associated X2AP messages handled by the gNB CU-CP and non-UE-associated X2AP messages handled by the eNB are reported to the near-RT RIC 320 over E2. The “pseudo eNB” configuration of the near-RT RIC 320 ensures that no UE is directly served by the eNB.

To establish connectivity with the gNB, the near-RT RIC 320 can use the E2 setup procedure, which is modeled after the EN-DC X2 setup procedure. On the other hand, to establish connectivity with the eNB, the near-RT RIC 320 uses the native X2 setup procedure. This connectivity enables the near-RT RIC 320 to control both the eNBs (BBU) and gNBs (CU-CP). The gNB CU-CP uses an E2 adapter to interface with the near-RT RIC 320 over E2AP. The E2 adapter uses a “blind-copy” filter, indicating that a copy of all X2AP messages (both UE-associated and non-UE-associated), handled by the gNB CU-CPs with other eNBs, would be transmitted over E2 to the near-RT RIC. The eNB BBU uses the native X2 adapter to interface with the near-RT RIC over X2AP, unlike the blind copy filter used for E2AP. Since the near-RT RIC (as a pseudo eNB) does not directly serve any UE, only non-UE-associated X2AP signaling messages are exchanged between the near-RT RIC and the eNBs.

Note that the non-RT-RIC 315 can receive the RAN state information pertaining to cells and UEs from the RAN over functions related to dual connectivity (DC) that can be handled by the near-RT RIC 320. The non-RT-RIC 315 can perform the following example policy decisions pertaining to DC over the A1 interface:
DC policy for bearers: This concerns making decisions on which UE-subscribed traffic flows can be configured as split-bearers between MN and SN, based on their QoS profile.
Primary/Secondary cell selection policy: This deals with establishing policy on which cell within an MN/SN should serve as a primary cell and secondary cells across LTE MN and NR SN nodes based on UE traffic profiles.
KPI optimization objective: The non-RT-RIC 315 sets KPI optimization objectives in terms of deciding which KPI should be optimized for a given cell or UE or specific UE-subscribed traffic flow(s).

Based on these policy decisions set by the non-RT-RIC 315, the near-RT RIC 320 can perform the following example RRM decisions pertaining to DC over the E2 interface:
SN Addition: The near-RT RIC 320 can decide the optimal secondary node for a given UE, and whether a given set of flows could be admitted for the UE in DC mode, as split bearers. The near-RT RIC 320 makes use of global channel conditions and load information across nodes to make optimal SN selection decisions.
SN and MN Handover: The near-RT RIC 320 can optimally manage mobility of DC UEs between their LTE MNs, and also between their NR SNs. Near-RT RIC 320 can optimally select target MN and SN nodes for a given UE and decide upon admission of flows across the target nodes. The near-RT RIC 320 leverages global RAN state information across the network to optimally manage mobility across MN and SNs.
MN and SN Modification: The near-RT RIC 320 can make decisions on primary cell selection within an MN/SN, intra MN mobility across cells within an eNB and intra-SN mobility across cells/DUs within a gNB.
Traffic split: The near-RT RIC 320 can perform data-driven optimization to optimally divide split-bearer user-plane data traffic across the LTE MN and NR SN for a given UE, based on global RAN state information, to maximize performance.

Both non-RT-RIC 315 and the near-RT RIC 320 controllers can make use of global RAN and UE state information, ML/AI techniques and data-driven programmable intelligence to choose appropriate policies/intents and manage fine grained RRM decisions, respectively.

For versions of E2AP which are an extension of X2AP, one problem is how the near-RT RIC 320 can intelligently perform traffic split for EN-DC UEs across the LTE and NR interfaces, so as to minimize the downlink user-plane RAN latency for the UE-subscribed traffic flow. Downlink user-plane RAN latency per packet is defined as the length of time it takes to transmit an IP packet, from the time it arrived at the eNB or gNB, till the time it is successfully transmitted to a given UE. Downlink user-plane RAN latency per packet depends on the following factors:
Number and size of protocol data units (PDUs) already queued in the buffers at the eNB/gNB. This impacts the waiting time for the incoming IP packet or PDU.
Instantaneous number of UEs associated to the LTE/NR cells of the eNB/gNB, and the background traffic subscribed by them, which impact the frequency-time spectrum resources allocated to the UE in the form of frequency-domain physical resource blocks (PRBs) and time-domain transmission time Intervals allocated to the UE.
Instantaneous channel conditions of UEs from the LTE/NR cells of the eNB/gNB, which impact the modulation and coding scheme (MCS) rates allocated to the UE by the eNB/gNB and hence, retransmission of PDUs.

The instantaneous number of UEs and instantaneous channel conditions of UEs impact the RLC layer and MAC layer latencies for the IP packet, and subsequently the queueing of PDUs in the buffers of the eNB/gNB. Hence, optimally splitting IP packets of UE-subscribed traffic flows which minimize the overall RAN latency is a hard problem to solve. This disclosure provides, inter alia, how information elements pertaining to the above factors can be obtained at the near-RT RIC 320 from the E2 interface, where its protocol specification E2AP is an extension of X2AP. This disclosure furthermore describes how to use this information to design an intelligent algorithm for optimally splitting the IP packets of UE-subscribed traffic flows between eNB and gNB to reduce the RAN latency of packets.

### Computation of Network Performance Indicators Based on Communications Between Nodes

Note that the content of the X2AP messages is embedded within the E2 message along with a header, indicating the global gNB ID. Using this header information, the near-RT RIC 320 can identify the gNB from which an X2AP message is being reported over E2. With E2AP, realized as an extension of X2AP, embodiments can extract the following messages and RAN information elements (IEs) at the near-RT RIC 320, reported from the eNB over X2, and gNB over E2. Note that (1) any message or IE from gNB to the near-RT RIC reported over E2 is UE-associated; and (2) any message or IE from eNB to the near-RT RIC 320 reported over X2 is non-UE-associated.

UE Identifiers. The following IEs are useful in the identification of the UE for which the near-RT RIC 320 performs the splitting of IP packets pertaining to the EN-DC bearer between the LTE and NR interfaces.
“MeNB UE X2AP ID” IE from “SgNB Addition Request” X2AP message: This IE is assigned by the LTE master eNB (MeNB) to uniquely identify a UE within an X2 interface with an NR gNB, at any point of time. This value changes for the same UE across EN-DC sessions. A session is defined as the length of time from the point at which EN-DC is established for the UE till the point at which EN-DC is released for the UE. That is, even if the same UE attempts to re-connect with the same gNB after disconnecting from the gNB, a different value is assigned for this IE pertaining to the UE by the MeNB.
“SgNB UE X2AP ID” IE from “SgNB Addition Request Acknowledge” or “SgNB Reconfiguration Complete” X2AP message: This IE is assigned by the NR secondary gNB (SgNB) to uniquely identify a UE within an X2 interface with the LTE MeNB, at any point of time. This value changes for the same UE across EN-DC sessions.
“s1-UL-GTPTunnelEndpoint” from “SgNB Addition Request”: This IE is assigned by the MeNB to identify the Serving gateway (S-GW) endpoint of the S1-U transport bearer for the radio bearer to be configured in SCG split-bearer mode. It is used for delivery of uplink PDUs from gNB to the eNB, and then to the S-GW via S1. If the UE remains connected to the eNB and its radio bearer context remains active, this value shall remain the same for the UE, even across EN-DC sessions and inter-SgNB handovers.

Cell association and RSRP Signaling information for the UE. The following IEs are useful to (i) identify the LTE and NR cells to which the UE is associated, and to (ii) receive the UE's RRC signal strength measurements.
“MeNB to SgNB Container” IE from “SgNB Addition Request” X2AP message: This IE gives information about the RSRP values of the NR cells, along with their NR—Physical Cell Identity (PCI) and the NR-CGI Information, as reported by the UE to the LTE master eNB.
“SgNB to MeNB Container” IE from “SgNB Addition Request Acknowledge” X2AP message: From the list of RSRP measurements for the NR cells reported by the UE, the SgNB selects: the primary serving cell of the secondary NR cell group within the SgNB, called PSCell; one or more secondary cell(s) of the secondary NR cell group within the SgNB, called SCell(s); and special cell of the secondary NR cell group within the SgNB, called SpCell. This IE gives information about the primary NR serving cell, the secondary NR cells and SpCell of the secondary cell group of the SgNB to serve the UE.
“MeNB Cell ID” IE from “SgNB Addition Request” X2AP message: This IE gives information about the ECGI of the primary E-UTRA cell (PCell) for the UE within the MeNB.
“UE NR Measurement Report” IE from “RRC Transfer” X2AP message: This IE gives the information about the UE with respect to both its serving and neighbor NR cells: (i) cell-wide signaling measurements (RSRP, RSRQ, SINR), (ii) synchronization signal (SS) beam-specific signaling measurement (RSRP, RSRQ, SINR) for each cell. For each NR serving cell, the UE also optionally reports the signaling measurements of its best NR neighbor cell. It also optionally reports the LTE E-UTRA neighbor cells of the eNB.
“RSRP Measurement Report List” IE from “Resource Status Update” X2AP message: This IE gives information about the list of UEs served by the MeNB, identified by the UE ID, and the RSRP values of the E-UTRA cells for the UE.
“CSI Report” from “Resource Status Update” X2AP message: This IE gives information about the CQI value reported by each UE, identified by its UE ID, for the E-UTRA cells in the serving eNB.

Cell Load and capacity: The following IEs are useful to identify the LTE and NR cell load in terms of number of UEs and bandwidth utilization.
“Radio Resource Status” IE from “Resource Status Update” X2AP message: This IE indicates the usage of physical resource blocks (PRB) and control channel elements (CCE) for scheduling downlink (and uplink) traffic for each E-UTRA cell within the LTE MeNB. This IE includes information about DL (/UL) guaranteed bit rate (GBR) PRB usage, DL (/UL) non-GBR PRB usage, and DL (/UL) PDCCH CCE utilization for each LTE cell within the MeNB.
“Load Indicator” IE from “Resource Status Update” X2AP message: This IE indicates the status of the load in each cell of the eNB and can be categorized as low load, medium load, high load, overload.
“51 TNL Load Indicator” IE from “Resource Status Update” X2AP message: This IE indicates the status of the S1 transport network load experienced by each cell of the eNB. To get the NR cell load, multiple steps can be followed: First, ascertain a number of “SgNB Reconfiguration Complete” messages where the corresponding “SgNB Addition Request” messages have distinct “S1-UL-GTP-TunnelEndpoint” value (as explained in Step (i) above). Note that there is a 1-1 UE-specific mapping from “SgNB Reconfiguration Complete” message to “SgNB Addition Request” message. The “SgNB Reconfiguration Complete” can be matched with “SgNB Addition Request” based on matching MeNB UE X2AP ID. This gives the number of distinct UEs who have been added to the SgNB. Second, complete” message to “SgNB Addition Request” message. The “SgNB Reconfiguration Complete” can be matched with “SgNB Addition Request” based on matching MeNB UE X2AP ID. This gives the number of distinct UEs who have been added to the SgNB. Third, we can extract the number of “UE Context Release” messages with matching “SgNB Release Request” and “SgNB Release Request Acknowledge” with matching MeNB UE X2AP ID value, or with matching “SgNB Release Required” and “SgNB Release Confirm” messages with matching SgNB UE X2AP ID value. From these UE ID values, the PCI to which the UEs were attached during their former EN-DC addition procedure could be determined. This is useful to determine how many UEs were released of their SCG resources from an NR-cell and SgNB. So, while computing the cell load in terms of number of UEs associated to the cell and to the gNB, it is useful to subtract the number of “UE Context Release” messages from the number of “SgNB Reconfiguration Complete” messages for the same cell or from the same gNB.
“Composite Available Capacity Group” IE under “Resource Status Update” X2AP message: This IE is used to indicate the available or residual resource level in the cell in downlink, along with a relative classification of the cell capacity with respect to other cells in the eNB.

Throughput: The following IE is useful to identify the number of bytes transmitted over the NR interface to a given UE for a length of time identified from a “start” timestamp till the “end” timestamp.
“Secondary RAT Usage Report List” IE from “Secondary RAT Data Usage Report” X2AP message: For each bearer (identified by E-RAB ID under “Secondary RAT Usage Report Item” IE) subscribed by the UE, we extract the “Usage count DL” (in bytes), the “Start timestamp” and “End timestamp” (in 64-bit seconds). The length of time from “start timestamp” to “end timestamp” is the period of active downlink data transfer, indicating a session. The “usage count DL” indicates the volume of downlink data transmitted (in bytes) during the session. Active throughput of the UE, hence, is defined as the ratio of the downlink data transmitted (in bytes) during the session to the duration of the session.

Number of successfully-transmitted IP packets. The following IEs are useful to identify the PDCP sequence number of a yet-to-be assigned PDCP PDU (or IP packet) from both the LTE and NR interfaces.
“E-RABs Subject to Status Transfer List” IE from “SN Status Transfer” message X2AP message: For each bearer (identified by E-RAB ID under “E-RABs Subject to Status Transfer Item” IE) subscribed by the UE, we extract the “DL COUNT Value Extended” and further extract the “DL COUNT Value for PDCP SN Length 18”. This IE is mainly an indicator for the SCG-split bearer traffic flow, split between LTE and NR interfaces for the same UE. Since the PDCP PDUs for the same bearer are split between LTE and NR interfaces, the eNB and gNB exchange this information with each other to indicate the other node about the last successfully transmitted PDCP PDU sequence number. In other words, the “DL COUNT Value for PDCP SN Length 18” indicates the sequence number for the next downlink PDCP PDU that does not yet have a sequence number.
Note that the PDCP PDU Sequence Number ranges from 0 to 4095, and then loops back to 0, for the PDUs served by the eNB. Whereas the PDCP PDU sequence number ranges from 0 to 262143, and then loops back to 0, for the PDCP PDUs served by the gNB.

### Rationale for EN-DC Traffic Split Based on Computed Network Performance Indicators

This disclosure describes an algorithm to optimize traffic split between LTE and NR interfaces so as to minimize the overall RAN latency for any EN-DC UE. In an aspect, a rationale behind the algorithm can be to minimize buffering at the eNB and gNB. Buffering happens when the incoming PDUs are queued in the logical buffer of the gNBs, waiting to get scheduled and transmitted over frequency-time resources to the UE. Higher buffering increases the RAN latency for the UE, as the PDU experiences a longer wait time before getting scheduled and transmitted to the UE. So, embodiments can aim to minimize or otherwise reduce eNB/gNB buffering by intelligent traffic split, in order to reduce the RAN latency for any EN-DC UE. However, eNB/gNB buffering information is not explicitly available over E2AP, as buffer status reporting is not part of 3GPP-standardized X2AP messages. Hence, embodiments can predict buffering at the eNB/gNB based on the network KPIs.

If the per-UE NR throughput relative to the fraction of the traffic split over the NR interface from the gNB for the UE (we simply call this relative NR throughput for the UE), decreases over time, then (i) it may indicate potential buffering pertaining to the bearer for the UE at gNB, or (ii) it may also indicate slower rate of arrival of IP packets, corresponding to the UE-subscribed traffic, to the gNB.

Relative NR throughput normalizes the differences in the UE throughput caused by the variation in traffic split over the NR interface across time. Potential buffering for the UE at gNB is more likely if its relative NR throughput, decreases over time across all or many UEs in the gNB, whose secondary RAT data usage report information is available at that time. This can further be correlated with the information about the cell load on NR cells in the gNB. With a higher cell load, the uncertainty on inferring buffering can be minimized.

If the UE's relative NR throughput decreases over time but does not necessarily correlate with the variation in the relative NR throughput across other UEs in the gNB, then there is a high degree of uncertainty in inferring that there is buffering for the UE at the gNB. However, we can check additional information such as UE's NR RSRP with respect to the NR cells of the gNB and the NR cell load within the gNB in this case and correlate them with UE's relative NR throughput. With a lower NR RSRP reported by the UE and a fairly-loaded NR cell that the UE is associated to, it is possible that the PDUs for the UE are getting buffered at the gNB. This can reduce uncertainty, however it may not be sufficient to infer buffering at the gNB.

To further reduce uncertainty in inferring buffering, we make use of the KPI information about the count of the number of successfully-transmitted PDCP PDUs (or the sequence number for the next yet-to-be-transmitted PDCP PDU) for the UE from both the eNB and gNB. We can compute the rate of increase in PDCP SN count relative to the ratio of the traffic split for the UE over the LTE and the NR interfaces from the eNB and gNB, respectively. We again call this relative PDCP SN count.

A lower rate of increase in relative PDCP SN count over the gNB and a lower correlation coefficient with the rate of increase in relative PDCP SN count for the UE from the eNB over time, along with a decreasing NR throughput, lower NR RSRP and fairly-loaded NR cell, reduce the uncertainty in inferring buffering at the gNB. Similarly, a lower rate of increase in relative PDCP SN count over the eNB and an increase in (or a lower correlation coefficient with) the first-order derivative of PDCP SN count for the UE from the gNB over time, along with a lower LTE RSRP reported by the UE and a loaded LTE cell (in terms of users RRC-connected to it, a higher PRB utilization and capacity utilization) to which the UE is associated, gives us the reduced uncertainty in inferring buffering at the eNB.

On the other hand, with a reduced relative NR throughput for the UE over time but when there is a (correlated) decrease in the first order derivatives of the relative PDCP SN counts over both the eNB and gNB, along with a fairly good RSRP and a lighter cell load for the UE with respect to both NR and LTE cells, there is a higher likelihood for inferring lower IP packet arrival rate at the gNB.

It can be useful to accurately predict whether the current UE is experiencing buffering at the eNB/gNB, or if it is experiencing a decrease in the arrival rate of the IP packets for its subscribed traffic. This is because it is buffering at the eNB/gNB, and not decrease in the arrival rate of the IP packets, that should necessitate the change in the fraction of the traffic split for the UE between the LTE and NR interfaces for near-term. The iterative and optimal changes in the traffic split fraction for the UE between the LTE and NR interfaces, based on accurate prediction of buffering at the eNB/gNB, would result in minimizing the overall RAN latency and improving throughput for the UE. Since it involves an iterative prediction and decision making based on the information available at every state and uncertainty across states, we use a reinforcement learning-based decision tree (RLDT) in the ENDC traffic split micro service xApp at the near-RT RIC to arrive at optimal traffic split fractions between LTE and NR interfaces for an EN-DC UE.

### Method for EN-DC Traffic Split Based on Computed Network KPIs

We now formally define the problem of learning to classify whether a current UE is experiencing buffering at the eNB/gNB, or if it is experiencing a decrease in the arrival rate of the IP packets for its subscribed traffic.

The below example operations can be conducted for online learning and MDP formulation:
We formulate the problem as a Markov Decision Process (MDP), where each episode (or timestep) of the MDP processes a new data point, containing the input features, using which the RLDT learner predicts a class label and accordingly chooses the traffic split rate.
A data point here refers to the set of IEs, covering one or more state transitions, which occur during the duration of a given episode.
Each state corresponds to an X2AP message (further related to the occurrence of an event) and the values of its IEs are the known features of the state. State transition follows the order of occurrence of events, which are reported to the near-RT RIC from the gNB CU-CP over E2.
The State space of the MDP includes all possible states, which encode partial information about a given data point. Note that all the input features might not be known features for a given data point, since we might not know the value of all the IEs by the lapse of a given episode.
State transition can be based on standard 3GPP X2AP procedures. With each state transition, there can be more known features to the data point.
The RLDT learner queries one or more states in each data point causing transition to different states in order to get values of the known features, from which it predicts a class label and reports the traffic split action back to the gNB.
If the prediction is correct, then the RLDT learner gets a positive reward; else, the reward is negative. It is required for the RLDT learner to reach a quicker convergence on prediction accuracy via positive rewards.
The more the number of state transitions covered for a given data point, the higher would be the number of known features for that data point, which would increase the accuracy of the prediction. This is because of a higher information entropy, which reduces the Gini impurity, with each state transition.
However, there is a cost associated with querying each state causing state transition. The cost is because of two reasons: (i) the depth of the tree should be small for efficiency, and (ii) transition to additional states takes time for the event to happen, resulting in additional IEs and additional known features—hence, additional time beyond the episode/timestep may be required to transit to newer states with querying. Hence, it can be required to achieve higher prediction accuracy with fewer queries.
Once the classification label is predicted, the near-RT RIC EN-DC xApp sends the determined traffic split fraction as control information to the gNB over E2. The gNB then executes the control action coming from the near-RT RIC xApp for the duration of the episode. During the episode, the gNB keeps sending reports of the X2AP messages along with the IEs to the near-RT RIC xApp, whenever the corresponding events occur in the RAN, and the above steps are repeated for the next lapse of the episode.

The below example operations can be conducted for deciding the traffic split fraction:
In a step one, assume any value of traffic split such that the fraction on either interface meets a pre-defined threshold. Compute the total number of successfully-sent IP packets on both the interfaces, when there is no buffering for the underlying RAN/traffic conditions. This can be done by counting the sum of the PDCP SN counts on both the interfaces (with cyclic sequence included). Moreover, at the initial few episodes, when the traffic is starting to flow, we do not expect immediate buffering at either eNB or gNB, since the buffer is not expected to be filled within the lapse of the initial episode.
In a step two, if there is buffering only in the eNB, decrease the fraction of traffic going on the LTE interface. Set the traffic split fraction on the eNB to the most-recent increase in the PDCP SN count on the eNB relative to the total number of transmitted IP packets (computed as in Step 1). Assign the reminder of the traffic split fraction to the NR interface.
In a step three, if there is buffering only in the gNB, decrease the fraction of traffic going on the NR interface. Set the traffic split fraction on the gNB to the most-recent increase in the PDCP SN count on the gNB relative to the total number of transmitted IP packets (computed as in Step 1). Assign the reminder of the traffic split fraction to the LTE interface.
In a step four, if there is buffering on both eNB and gNB, then identify which has a lower relative increase in PDCP SN count, and reduce the traffic split ratio on that interface (as discussed in steps 2 and 3). This is to ensure that the buffer does not grow out of proportion on any interface.
In a step five, if the slower rate of growth in PDCP SN count is attributed to factors other than buffering (such as slower incoming traffic rate, etc.), do not change the traffic split ratio. Retain the same traffic-split fraction on both the LTE and NR interfaces, as in the previous episode.

An example can demonstrate how DC xAPP can harness ML/AI models and leverage predictive analytics to intelligently split traffic flow between LTE eNB and NR gNB for an EN-DC UE. An example EN-DC deployment can include a LTE eNB and a NR gNB connected via X2. Sets of UEs can be served by LTE eNB only, by NR gNB only and in EN-DC mode by eNB and gNB jointly. We consider an EN-DC UE, subscribing to an enhanced mobile broadband (eMBB) traffic, which is considered both throughput-intensive as well as latency-critical (e.g. AR/VR). The eNB and gNB are connected to the near RT RIC, which hosts the DC xAPP, over E2. Starting with a 50% traffic split across eNB and gNB for the UE at a given time t, the DC xAPP can change the fraction of the traffic split across the two RAT interfaces over time, based on predicted eNB and gNB buffer sizes in near-RT and in the near future. The xAPP can decide on the optimal traffic split across time, which avoids buffer overflows or heavy queuing due to congestion in the RAN. This is because buffer management is critical to QoE of an eMBB traffic, since larger queues in the buffers increase RAN latency and adversely impact RAN throughput. For discussion purposes, we assume that a minimum 90% QoE is desired for provisioning the eMBB traffic.

An example initial traffic split can include, e.g., a 50% traffic split for the EN-DC UE at an initial time t with eNB and gNB buffer occupancy at 30% and 60% respectively. The traffic split function in the EN-DC xAPP uses RLDT to predict buffer occupancy class label for the eNB and gNB into the near-future. It uses relevant input features like signal strength, instantaneous buffer size, PRB utilization for the UE and other RAN KPIs, as received from the RAN over E2. eNB and gNB buffer sizes can be predicted and thus, QoE of the EN-DC can also be predicted, at time slots t+10, t+20 and t+30. Congestion at the gNB (with 10% buffer occupancy, indicating overflow) at time t+30 can also be predicted. This could potentially drop the QoE to 85% at time t+30, which is below the minimum QoE threshold. So, at time t+10, the DC xAPP can direct the RAN over E2 to change the traffic such that 65% of the PDCP PDUs go over the LTE interface, while the remaining goes over the NR interface. Again, using online ML or deep learning models, the DC xAPP still predicts a 100% buffer occupancy at time t+30. Thus, at time t+20, the DC xAPP can instruct the RAN to change the traffic split ratio such that 100% of PDCP traffic goes over the LTE eNB, while nothing goes over the NR gNB. Now, the RLDT algorithm in the xAPP predicts 85% and 55% buffer occupancy levels over eNB and gNB at time t+30 respectively, thereby avoiding the likelihood of the previously predicted RAN congestion in the gNB at time t+30. Hence, the QoE is expected to meet the minimum threshold at time t+30, due to the prediction-based optimized traffic split by the DC xAPP in the near-RT RIC. Furthermore, at time t+30, the DC xAPP can again change the traffic split such that 40% of PDCP traffic goes over LTE, and the remaining 60% goes over the NR interface. Similar and balanced buffer occupancy levels can be predicted across the eNB and gNB for time slots t+40 and t+50. In this example, t, t+10, t+20, t+30, . . . are all episodes or time steps. Thus, RLDT in the xAPP can harness intelligence using data driven analytics in the xAPPs of the near-RT RIC, thereby helping towards RAN network-wide optimization.

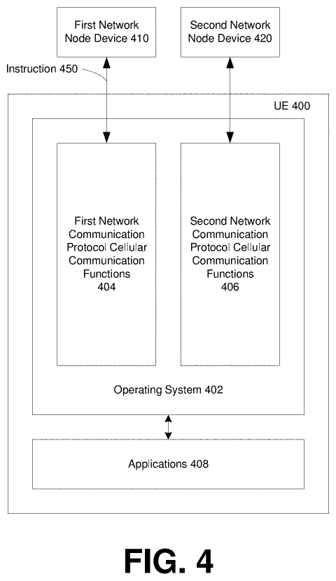

FIG. 4 illustrates an example user equipment (UE), in accordance with various aspects and embodiments of the subject disclosure. The example UE 400 can implement, e.g., the 5G EN-DC UE 230 illustrated in FIG. 2, or either of the UEs 102 illustrated in FIG. 1.

The example UE 400 can comprise, inter alia, an operating system 402 and applications 408. The applications 408 can send and receive network communications via the operating system 402. The operating system 402 can support dual mode connectivity, by including first network communication protocol cellular communication functions 404 as well as second network communication protocol cellular communication functions 406.

The first network communication protocol cellular communication functions 404 can send and receive communications to/from a first network node device 410, e.g., an LTE RAN network node device. The second network communication protocol cellular communication functions 406 can send and receive communications to/from a second network node device 420, e.g., a 5G NR RAN network node device. The operating system 402 can be configured to select whether to use, or an extent of use, of the first network communication protocol cellular communication functions 404 and the second network communication protocol cellular communication functions 406 for UE 400 network communications.

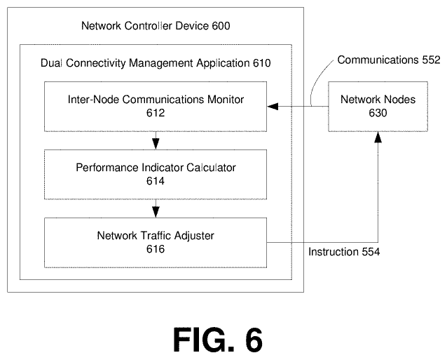

In an example embodiment, communications with either of the network node devices 410 or 420, e.g., communications with first network node device 410, can include an instruction 450. The instruction 450 can instruct operating system 402 to regarding an extent of use of instructed cellular communication functions, namely, either first network communication protocol cellular communication functions 404 or second network communication protocol cellular communication functions 406. The operating system 402 can be configured to use instructed cellular communication functions according to instruction 450. As described further herein, the instruction 450 can be initiated at a network controller device, e.g., as illustrated in FIG. 6, in accordance with the techniques described herein, in order to balance traffic flows at first and second network node devices 410 and 420.

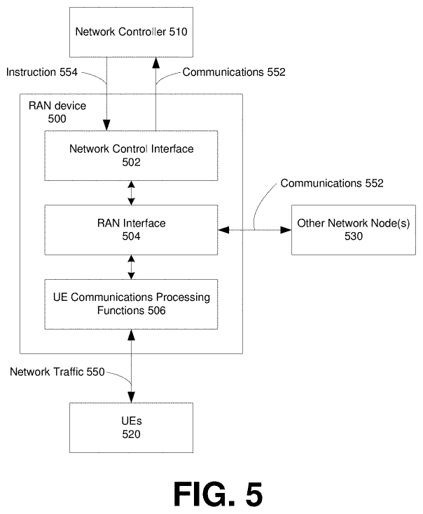

FIG. 5 illustrates an example RAN device, in accordance with various aspects and embodiments of the subject disclosure. The example RAN device 500 can implement, e.g., either of the network node devices 410 or 420 illustrated in FIG. 4, a device of disaggregated NR gNB 330, disaggregated NR gNB 340, or disaggregated LTE eNB 350 illustrated in FIG. 3, a device of LTE eNB 201 or NR gNB 220 illustrated in FIG. 2, or a device of either of the network nodes 104 illustrated in FIG. 1.

The RAN device 500 can comprise a network control interface 502 configured to send and receive communications 552 and instruction 554 with a network controller 510 such as a near-RT RIC. In an embodiment, the network control interface 502 can comprise an E2 interface such as illustrated in FIG. 3. The RAN device 500 can also comprise a RAN interface 504 configured to send and receive communications 552 with other network node(s) 530, e.g., other RAN devices at other network node(s). In an embodiment, the RAN interface 504 can comprise an X2 interface such as illustrated in FIG. 3. The RAN device 500 can also comprise UE communications processing functions 506 configured to send and receive network traffic 550 communications involving UEs 520.

The RAN device 500 can implement either a first network communication protocol, e.g., 4G LTE, or a second network communication protocol, e.g., 5G NR. The other network node(s) 530 can include network nodes that implement different network communication protocols. For example, if device 500 implements 4G LTE, then the other network node(s) 530 can include network nodes that implement 5G NR, and vice versa.

The RAN device 500 can be configured to send and receive communications 552 with other network nodes(s) 530 as desired to coordinate operations of the RAN device 500 and the other network nodes(s) 530. The RAN device 500 can be configured to forward the communications 552 to the network controller 510. Based on the communications 552, the network controller 510 can calculate an appropriate balance of network traffic between RAN device 500 and the other network node(s) 530, according to the techniques described herein. The network controller 510 can send an instruction 554 to RAN device 500, wherein the instruction 554 implements the appropriate balance of network traffic.

In some embodiments, the instruction 554 can include many instructions similar to instruction 450, illustrated in FIG. 4, which instructions can be delivered by RAN device 500 to UEs 520. The UEs 520 can then change their selected communication protocols to balance network traffic. In other embodiments, the instruction 554 can include instructions implemented at RAN device 500 and other network node(s) 530. RAN device 500 and other network node(s) 530 can be configured to balance network traffic 550 between RAN device 500 and other network node(s) 530.

FIG. 6 illustrates an example network controller device, in accordance with various aspects and embodiments of the subject disclosure. The example network controller device 600 can implement a network controller 510 illustrated in FIG. 5, a near-RT RIC 320 illustrated in FIG. 3, or for example a device among the communication service provider network(s) 106 illustrated in FIG. 1.

The example network controller device 600 can include, inter alia, a dual connectivity management application 610. The dual connectivity management application 610 can include an inter-node communications monitor 612, a performance indicator calculator 614, and a network traffic adjuster 616.

The network controller device 600 can receive communications 552 from network nodes 630, wherein the communications 552 are introduced in FIG. 5, and wherein network nodes 630 can include, e.g., RAN device 500 and other network node(s) 530, illustrated in FIG. 5. The network controller device 600 can also send instruction 554 to network nodes 630, wherein instruction 554 is also described in connection with FIG. 5.

In an example, the inter-node communications monitor 612 can monitor the communications 552. The performance indicator calculator 614 can use the communications 552 to calculate performance indicators and/or other information associated with network nodes 630, in accordance with any of the techniques described herein. For example, buffer growth rates can be predicted for network nodes 630. The network traffic adjuster 616 can adjust relative network traffic volumes to be processed by the different network nodes among network nodes 630. The network traffic adjuster 616 can send instruction 554 to the network nodes 630, or to UEs via the network nodes 630, wherein the instruction 554 adjusts network traffic volumes handled by the network nodes 630.

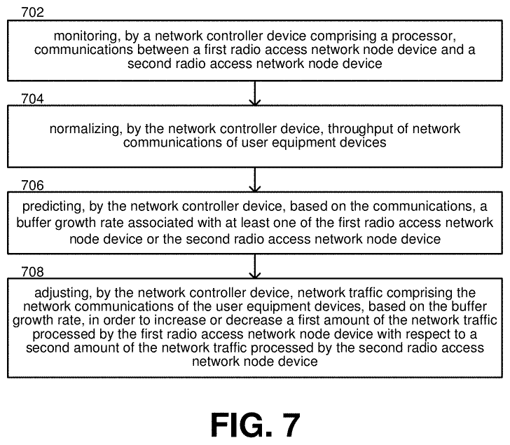

FIG. 7 is a flow diagram representing example operations of a network controller device, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 7 can be performed, for example, by a network controller device 600 such as illustrated in FIG. 6. In some embodiments, the network controller device 600 can comprise a near-RT RIC 320 that is coupled with network nodes 330, 340, 350 via E2 interfaces, while communications between network nodes 330, 340, 350 can be made via X2 interfaces, such as illustrated in FIG. 3.

Example operations include operation 702, which represents monitoring, by a network controller device 600 comprising a processor, communications 552 between a first radio access network node device of network nodes 630 and a second radio access network node device of network nodes 630. For example, inter-node communications monitor 612 can monitor communications 552.

The first radio access network node device of operation 702, e.g., a first RAN device among network nodes 630, can use a first network communication protocol, such as 4G LTE, to facilitate a first grouping of network communications of UE devices such as 520. Meanwhile, the second radio access network node device, e.g., a second RAN device among network nodes 630, can use a second network communication protocol, such as 5G NR, to facilitate a second grouping of the network communications of the UE devices 520. For example, the second radio access network node device can handle 5G communications of UEs 520 while the first radio access network node device can handle 4G LTE communications of UEs 520.

Example operations can furthermore include operation 704, which represents normalizing, by the network controller device 600, the throughput of the network communications of the UE devices. For example, the performance indicator calculator 614 can determine a relative NR throughput as described herein, as a step involved in determining performance indicators.

Example operations can furthermore include operation 706, which represents predicting, by the network controller device 600, based on the communications 552, a buffer growth rate associated with at least one of the first radio access network node device or the second radio access network node device of network node(s) 630. For example, the performance indicator calculator 614 can predict a buffer growth rate of, e.g., first radio access network node device. In some embodiments, predicting the buffer growth rate can comprise determining a performance indicator based on the communications 552, and using the performance indicator to predict the buffer growth rate. In some embodiments, predicting the buffer growth rate can comprise evaluating magnitudes of time and frequency resource allocations to the UE devices 520, among other operations.

In some embodiments, predicting the buffer growth rate can comprise evaluating a throughput of the network communications of the UE devices through at least one of the first radio access network node device or the second radio access network node device of network nodes 630. The throughput of the network communications of the UE devices, at the first radio access network node device or the second radio access network node device of network nodes 630, can be inversely correlated with the buffer growth rate at the first radio access network node device or the second radio access network node device. In some embodiments, predicting, based on the communications 552, the buffer growth rate can be facilitated by a machine learning model to predict buffer growth rates based on network node device communications 552 between radio access network node devices.

Example operations can furthermore include operation 708, which represents adjusting, by the network controller device 600, network traffic comprising the network communications of the user equipment devices, based on the buffer growth rate, in order to increase or decrease a first amount of the network traffic processed by the first radio access network node device with respect to a second amount of the network traffic processed by the second radio access network node device. For example, the network traffic adjuster 616 can send instruction 554 to adjust network traffic processed by network nodes 630.

Adjusting the network traffic based on the buffer growth rate can generally comprise increasing the first amount of the network traffic (handled by a first one of network nodes 630) with respect to the second amount of the network traffic (handled by a second one of network nodes 630) when a first predicted buffer growth rate at the first radio access network node device is less than a second predicted buffer growth rate at the second radio access network node device, or vice versa. In other words, network traffic can be diverted away from network nodes with higher predicted buffer growth rates, and towards network nodes with lower predicted buffer growth rates.

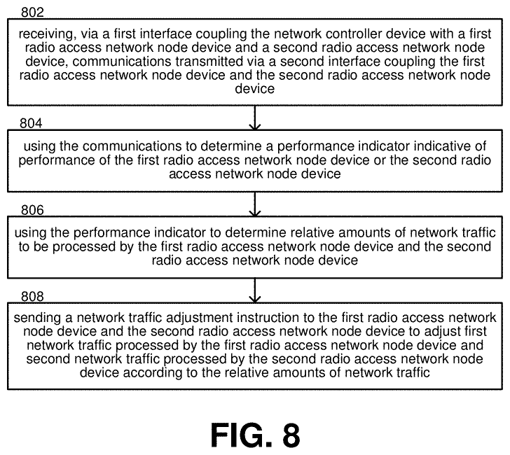

FIG. 8 is a flow diagram representing another example set of operations of a network controller device, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

Similar to FIG. 7, the operations illustrated in FIG. 8 can be performed, for example, by a network controller device 600 such as illustrated in FIG. 6. In some embodiments, the network controller device 600 can comprise a near-RT RIC 320 that is coupled with network nodes 330, 340, 350 via E2 interfaces, while communications between network nodes 330, 340, 350 can be made via X2 interfaces, such as illustrated in FIG. 3.

Example operations can include operation 802, which represents receiving, via a first interface (e.g., an E2 interface) coupling the network controller device 300 with a first radio access network node device, e.g., a device at node 350, and a second radio access network node device, e.g., a device at node 340, communications 552 transmitted via a second interface (e.g., an X2 interface) coupling the first radio access network node device (at node 350) and the second radio access network node device (at node 340).

The first radio access network node device (at node 350) can use a first network communication standard, e.g., 4G LTE, to facilitate a first portion of network communications of UE devices, such as 4G LTE communications. The second radio access network node device (at node 340) can use a second network communication standard, e.g., 5G, to facilitate a second portion of the network communications of the UE devices, such as 5G communications.

Example operations can furthermore include operation 804, which represents using the communications 552 to determine a performance indicator indicative of performance of the first radio access network node device (at node 350) or the second radio access network node device (at node 340). In some embodiments, the performance indicator can comprise a first cell load at the first radio access network node device (at node 350) or a second cell load at the second radio access network node device (at node 340). In some embodiments, the performance indicator can comprise a first throughput at the first radio access network node device (at node 350) or a second throughput at the second radio access network node device (at node 340). Any of the various other performance indicators described herein can be determined at operation 804.

Example operations can furthermore include operation 806, which represents using the performance indicator determined at operation 804 to determine relative amounts of network traffic to be processed by the first radio access network node device (at node 350) and the second radio access network node device (at node 340). In some embodiments, operation 806 can comprise using the performance indicator determined at operation 804 to predict a buffer growth rate at the first radio access network node device (at node 350) or the second radio access network node device (at node 340), and using the buffer growth rate to determine the relative amounts of network traffic.

Example operations can furthermore include operation 808, which represents sending a network traffic adjustment instruction, e.g., instruction 554, to the first radio access network node device (at node 350) and the second radio access network node device (at node 340) to adjust first network traffic processed by the first radio access network node device (at node 350) and second network traffic processed by the second radio access network node device (at node 340), according to the relative amounts of network traffic determined at operation 806.

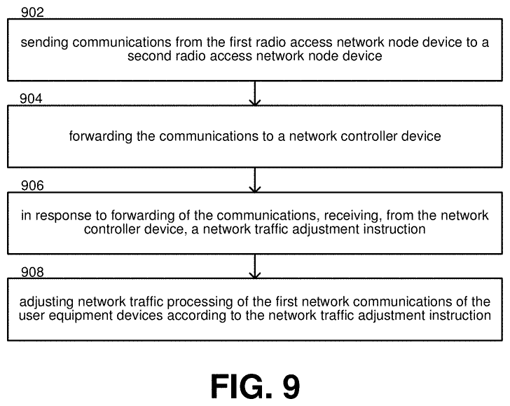

FIG. 9 is a flow diagram representing example operations of a network node device, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 9 can be performed, for example, by a RAN device 500 such as illustrated in FIG. 5. Example operations can include operation 902, which represents sending communications 552 from the first radio access network node device 500 to a second radio access network node device, e.g., a network node device among other network node(s) 530. The first radio access network node device 500 can use a first network communication standard to facilitate first network communications, e.g., communications associated with network traffic 550 of UE devices 520. The second generation network node device can use a second network communication standard to facilitate second network communications of the UE devices 520. For example, the first network communication standard can comprise a LTE network communication standard and the second network communication standard can comprise a 5G network communication standard, or vice versa. Sending the communications 552 from the first radio access network node device 500 to the second radio access network node device can comprise sending the communications 552 via an X2 interface.

Example operations can furthermore include operation 904, which represents forwarding the communications 552 to a network controller device such as network controller device 510. Forwarding the communications 552 to the network controller 510 can comprise forwarding the communications 552 via an E2 interface.

Example operations can furthermore include operation 906, which represents, in response to forwarding of the communications 552 at operation 904, receiving, from the network controller device 510, a network traffic adjustment instruction 554, wherein the network traffic adjustment instruction 554 adjusts a first amount of network traffic processed by the first radio access network node device 500 relative to a second amount of network traffic processed by the second radio access network node device.

Example operations can furthermore include operation 908, which represents adjusting network traffic processing of the first network communications of the UE devices 520 (namely, adjusting processing of network traffic 550) according to the network traffic adjustment instruction 554. As described herein, adjustments can be made directly at the RAN device 500, or indirectly as a result of instructions (such as instruction 450) sent to UEs 520.

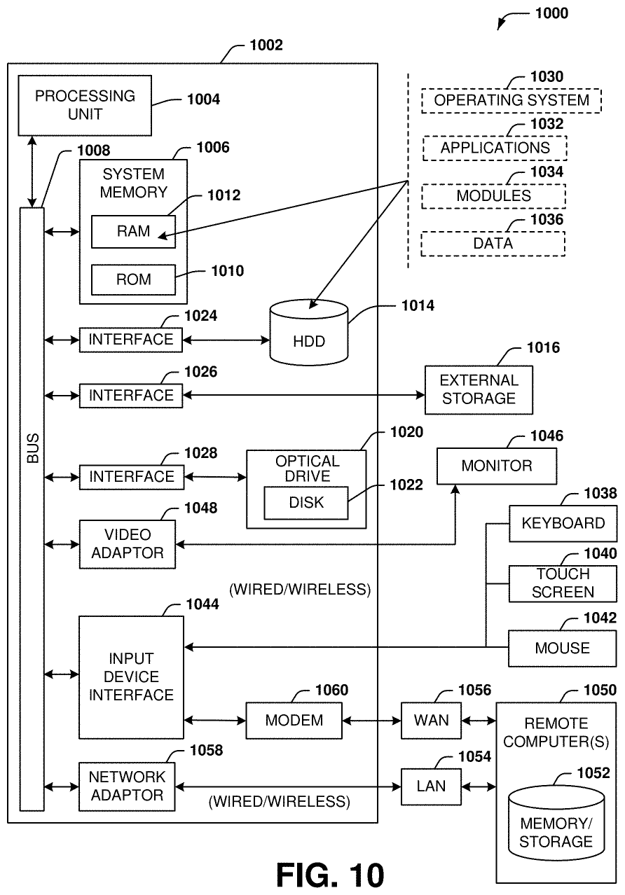

FIG. 10 is a block diagram of an example computer that can be operable to execute processes and methods in accordance with various aspects and embodiments of the subject disclosure. The example computer can be adapted to implement, for example, a UE 400, RAN device 500, a network controller device 600, or other computing devices described herein.

FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
monitoring, by a network controller device comprising a processor, communications between a first radio access network node device and a second radio access network node device,
wherein the first radio access network node device uses a first network communication protocol to facilitate a first grouping of network communications of user equipment devices, and wherein the second radio access network node device uses a second network communication protocol to facilitate a second grouping of the network communications of the user equipment devices;
predicting, by the network controller device, based on the communications, a buffer growth rate associated with at least one of the first radio access network node device or the second radio access network node device; and
adjusting, by the network controller device, network traffic comprising the network communications of the user equipment devices, based on the buffer growth rate, in order to increase or decrease a first amount of the network traffic processed by the first radio access network node device with respect to a second amount of the network traffic processed by the second radio access network node device.

2. The method of claim 1, wherein the network controller device comprises a radio access network intelligent controller device.

3. The method of claim 1, wherein the first network communication protocol comprises a long term evolution network communication protocol and wherein the second network communication protocol comprises a fifth generation network communication protocol.

4. The method of claim 1, wherein the communications between the first radio access network node device and the second radio access network node device comprise communications sent via an X2 interface.

5. The method of claim 1, wherein predicting the buffer growth rate comprises evaluating magnitudes of time and frequency resource allocations to the user equipment devices.

6. The method of claim 1, wherein predicting the buffer growth rate comprises determining a performance indicator based on the communications, and using the performance indicator to predict the buffer growth rate.

7. The method of claim 1, wherein predicting the buffer growth rate comprises evaluating a throughput of the network communications of the user equipment devices through at least one of the first radio access network node device or the second radio access network node device.

8. The method of claim 7, further comprising normalizing, by the network controller device, the throughput of the network communications of the user equipment devices.

9. The method of claim 7, wherein the throughput of the network communications of the user equipment devices, at the first radio access network node device or the second radio access network node device, is inversely correlated with the buffer growth rate at the first radio access network node device or the second radio access network node device.

10. The method of claim 1, wherein adjusting the network traffic based on the buffer growth rate comprises increasing the first amount of the network traffic with respect to the second amount of the network traffic when a first predicted buffer growth rate at the first radio access network node device is less than a second predicted buffer growth rate at the second radio access network node device, or vice versa.

11. The method of claim 1, wherein predicting, based on the communications, the buffer growth rate is facilitated by a machine learning model to predict buffer growth rates based on network node device communications between radio access network node devices.

12. A network controller device, comprising:
a processor; and
a memory that stores executable instructions that, when executed by the processor, facilitate performance of operations, comprising:
receiving, via a first interface coupling the network controller device with a first radio access network node device and a second radio access network node device, communications transmitted via a second interface coupling the first radio access network node device and the second radio access network node device;
using the communications to determine a performance indicator indicative of performance of the first radio access network node device or the second radio access network node device;
using the performance indicator to determine relative amounts of network traffic to be processed by the first radio access network node device and the second radio access network node device; and
sending a network traffic adjustment instruction to the first radio access network node device and the second radio access network node device to adjust first network traffic processed by the first radio access network node device and second network traffic processed by the second radio access network node device according to the relative amounts of network traffic.

13. The device of claim 12, wherein using the performance indicator to determine the relative amounts of network traffic comprises using the performance indicator to predict a buffer growth rate at the first radio access network node device or the second radio access network node device, and using the buffer growth rate to determine the relative amounts of network traffic.

14. The device of claim 12, wherein the first radio access network node device uses a first network communication standard to facilitate a first portion of network communications of user equipment devices, and wherein the second radio access network node device uses a second network communication standard to facilitate a second portion of the network communications of the user equipment devices.

15. The device of claim 12, wherein the performance indicator comprises a first cell load at the first radio access network node device or a second cell load at the second radio access network node device.

16. The device of claim 12, wherein the performance indicator comprises a first throughput at the first radio access network node device or a second throughput at the second radio access network node device.

17. A non-transitory machine-readable storage medium, comprising executable instructions that, when executed by a processor, facilitate performance of operations at a first radio access network node device, comprising:
sending communications from the first radio access network node device to a second radio access network node device, wherein the first radio access network node device uses a first network communication standard to facilitate first network communications of user equipment devices, and wherein the second generation network node device uses a second network communication standard to facilitate second network communications of the user equipment devices;
forwarding the communications to a network controller device;
in response to the forwarding, receiving, from the network controller device, a network traffic adjustment instruction, wherein the network traffic adjustment instruction adjusts a first amount of network traffic processed by the first radio access network node device relative to a second amount of network traffic processed by the second radio access network node device; and
adjusting network traffic processing of the first network communications of the user equipment devices according to the network traffic adjustment instruction.

18. The non-transitory machine-readable storage medium of claim 17, wherein sending the communications from the first radio access network node device to the second radio access network node device comprises sending the communications via an X2 interface.

19. The non-transitory machine-readable storage medium of claim 17, wherein forwarding the communications to the network controller device comprises forwarding the communications via an E2 interface.

20. The non-transitory machine-readable storage medium of claim 17, wherein the first network communication standard comprises a long term evolution network communication standard and the second network communication standard comprises a fifth generation network communication standard.
